(19) United States
(12) Patent Application Publication
(10) Pub. No.: US 2026/0210703 A1
(43) Pub. Date: Jul. 23, 2026

(54) HIGH-PRECISION RIGHT-ANGLE DETECTION DEVICE AND METHOD

(71) Applicant: INNOVATION ACADEMY FOR PRECISION MEASUREMENT SCIENCE AND TECHNOLOGY, CAS, Wuhan (CN)

(72) Inventors: Hua GUAN, Wuhan (CN); Shaolong CHEN, Wuhan (CN); Xurui CHANG, Wuhan (CN); Yao HUANG, Wuhan (CN); Kelin GAO, Wuhan (CN)

(73) Assignee: INNOVATION ACADEMY FOR PRECISION MEASUREMENT SCIENCE AND TECHNOLOGY, CAS, Wuhan (CN)

(21) Appl. No.: 19/377,079

(22) Filed: Nov. 3, 2025

(30) Foreign Application Priority Data
Jan. 21, 2025 (CN) 2025100934739

(51) Int. Cl. G01B 11/26

(52) U.S. Cl. CPC G01B 11/26

(57) ABSTRACT

The present invention discloses a high-precision right-angle detection device and method. By utilizing two right-angles surfaces of the component under measurement to reflect an incident laser and an emitted laser, the first-order Doppler effect is calculated. This is achieved by measuring the ion spectra of metastable state lithium ions using both the incident and emitted lasers. Subsequently, the angle between the incident and emitted laser is deduced based on the first-order Doppler effect. Finally, the right-angle of the component under measurement is determined. The invention employs the frequency of ion transition spectral lines as a reference, which serves as a natural and stable benchmark that does not require periodic calibration. Additionally, atomic or molecular transition spectral lines can also be utilized as references. A wide variety of ions, atoms, molecules, and their corresponding spectral lines are available, offering extensive wavelength coverage and diverse options.

### CROSS-REFERENCE TO RELATED APPLICATIONS

The application claims priority to Chinese patent application No. 2025100934739, filed on Jan. 21, 2025, the entire contents of which are incorporated herein by reference.

### TECHNICAL FIELD

The present invention pertains to the technical field of precise angle measurement, and more specifically, it relates to a high-precision right-angle detection device as well as a high-precision right-angle detection method.

### BACKGROUND

Angle measurement holds great significance and extensive application in precise measurement and positioning. In the precision processing of industrial manufacturing, such as aerospace, automotive manufacturing, and electronic component manufacturing, the accuracy of angles is critical to ensuring product quality and performance. Even minor angular errors may result in severe assembly issues or functional deviations. In the calibration of optical systems and equipment, including laser devices, optical instruments, photolithography machines, and other related fields, high-precision angle measurement or evaluation directly impacts imaging quality and measurement accuracy. Furthermore, in domains such as navigation and attitude control, metrology and standards, architectural and engineering surveying, high-precision angle measurement or evaluation is essential for ensuring the reliability and precision of navigation, metrology, and engineering processes. In these areas, even slight angular deviations can lead to significant problems. Consequently, high-precision angle measurement plays a crucial role in advancing technological progress, enhancing product quality, and ensuring safety.

In particular, the precise measurement of right angles is critical in numerous fields, especially when constructing or ensuring the direct perpendicularity, parallelism, and geometric accuracy of structural components, optical paths, etc. This applies to high-precision optical equipment such as photolithography machines and precision optical experiments, where the perpendicularity and parallelism between certain components directly influence the final performance of the equipment and the accuracy of research results. For example, right-angle mirrors and right-angle prisms serve as excellent tools for achieving parallel optical paths. If absolute right angles can be achieved, absolute parallel optical paths can also be realized. Consequently, it is essential to process or screen components with right angles that are either completely or infinitely close to 90°. Currently, the most accurate devices for angle measurement are the photoelectric autocollimator and the laser interferometer. The photoelectric autocollimator emits a light beam and detects the offset of the reflected beam to calculate angular changes, achieving an accuracy typically at the sub-arcsecond level, 10⁻⁶ radian. The laser interferometer measures angles by analyzing the phase difference generated by laser interference, achieving an accuracy at the 0.01 arcsecond level, 10⁻⁷ radian.

### SUMMARY

The objective of the present invention is to provide a high-precision right-angle detection device and method, addressing the above-mentioned problems existing in prior art.

The above-mentioned objective of the present invention is accomplished through the following technical measures:

A high-precision right-angle detection device comprises a test component, an ion source, a laser modulation module, a fluorescence collection module, and a data processing module. The laser modulation module generates an incident laser beam that is directed onto one of the right-angle surfaces of the component under measurement. After two reflections, the emitted laser beam is reflected off the other right-angle surface. The ion source prepares ions and emits them to form an ion beam with a predetermined velocity. This ion beam is then collimated and exits in a direction perpendicular to the incident laser beam. The collimated ion beam passes through both the incident and exit laser beams. The interaction between the lasers and the ions induces transitions, causing the ions to emit fluorescence signals. The fluorescence collection module captures these fluorescence signals, converts them into electrical signals, and outputs them to the data processing module. Based on the electrical signals and the laser frequency provided by the laser modulation module, the data processing module analyzes the saturated absorption spectrum to determine its center frequency. Additionally, the data processing module is connected to the ion source, the laser modulation module, and the fluorescence collection module via signal transmission lines for coordinated operation.

As described above, the incident laser is aligned parallel to the angle bisectors of the two right-angle surfaces of the component under measurement. Additionally, the planes containing both the incident and emitted lasers are oriented perpendicular to the angle bisectors of the two right-angle surfaces of the component under measurement.

As described above, the laser modulation module comprises a laser, an acousto-optic modulator, a first fiber coupling head, a second fiber coupling head, an optical fiber, and a horizontal displacement frame. The output of the laser is connected to the input of the acousto-optic modulator. The output of the acousto-optic modulator is linked to one end of the optical fiber via the first fiber coupling head, while the other end of the optical fiber is connected to the second fiber coupling head. The second fiber coupling head is mounted on the horizontal displacement frame. It is positioned at the same height as the component under measurement and aligned with one of the right-angle surfaces of the component under measurement. Additionally, the data processing module is connected to both the modulation input terminal of the acousto-optic modulator and the laser through signal transmission lines.

As outlined above, the fluorescence collection module comprises an imaging lens and a photomultiplier tube. The data processing module is interconnected with the photomultiplier via a signal transmission line. The imaging lens serves to focus the fluorescence signal emitted by ions onto the photosensitive surface of the photomultiplier tube. Upon detection of the fluorescence signal, the photomultiplier tube converts it into a voltage pulse signal, which is subsequently transmitted to the data processing module. Based on the voltage pulse signal and the laser frequency output from the laser, the data processing module derives the line shape of the saturated absorption spectrum and performs fitting analysis to determine the center frequency of the saturated absorption spectrum.

As previously discussed, the ion source has the potential to be substituted with either an atomic source or a molecular source.

A high-precision right-angle detection method, which employs the above-mentioned high-precision right-angle detection device, consists of the following steps:
Step 1: The data processing module activates the ion source. The ion source generates ions, guides them out to form an ion beam at a predetermined velocity, and subsequently outputs the collimated ion beam.
Step 2: Initiate the movement of the horizontal displacement frame. The data processing module activates the laser and the acousto-optic modulator. The acousto-optic modulator generates an incident laser beam, which strikes the first right-angle surface of the component under measurement. After undergoing two reflections, the emitted laser beam is reflected off the second right-angle surface for the initial measurement. A saturated absorption spectral line is obtained from this first measurement, and the center frequency f₁ of the first measurement is determined through fitting based on the acquired saturated absorption spectral line.
Step 3: Re-position the horizontal displacement frame. Subsequently, the data processing module activates the laser and the acousto-optic modulator. The acousto-optic modulator emits the incident laser beam, which strikes the second right-angle surface of the component under measurement. After undergoing two reflections, the emitted laser beam is reflected off the first right-angle surface for a second measurement. A saturated absorption spectral line is obtained from the second measurement, and the center frequency f₂ of the second measurement is determined through fitting based on this saturated absorption spectral line.
Step 4: Determine the angle θ of the component under measurement based on the center frequency f₁ from the first measurement and the center frequency f₂ from the second measurement.
Step 5: Repeat step 2 through 4 over multiple cycles to determine the multiple angles θ for component under measurement. Calculate the weighted average of the angles θ obtained from component under measurement to derive the final angle of the target component under measurement.

As previously stated, the laser path of the first measurement is oriented in the opposite direction to that of the second measurement.

As previously stated, Step 4 involves calculating the angle θ of the component under measurement using the formula provided below:

$$ϕ = arcsin \frac{{f}_{1} - {f}_{2}}{2 {f}_{0} β}$$

$$θ = \frac{π}{2} + \frac{ϕ}{2}$$

In the formula, φ represents the angle between the incident laser and the emitted laser, f₀ represents the actual transition frequency of the ion, and β signifies the ratio of the ion's velocity to the speed of light.

The present invention, in comparison to existing technologies, offers the following advantages:
(1) The invention utilizes the frequency of ion transition spectral lines as a reference, which serves as a natural and inherently stable reference source, eliminating the need for periodic calibration. Additionally, atomic or molecular transition spectral lines can also be employed as alternative references.
(2) The invention employs ion beams (which may alternatively be substituted with atomic or molecular beams) for measurement. A wide variety of ions (atoms or molecules) and their corresponding spectral lines are available, providing extensive wavelength coverage and enabling diverse options for selection.
(3) The measurement accuracy of the invention is exceptionally high, achieving precision exceeding 0.01 arcseconds. Furthermore, by optimizing the ion (atoms or molecules) system and enhancing the velocity of the ions (atoms or molecules), the measurement accuracy can be further improved to 0.001 arcseconds, significantly surpassing the performance of current traditional methods.

### BRIEF DESCRIPTION OF DRAWINGS

FIG. 1 provides a flowchart illustrating the method of the present invention.

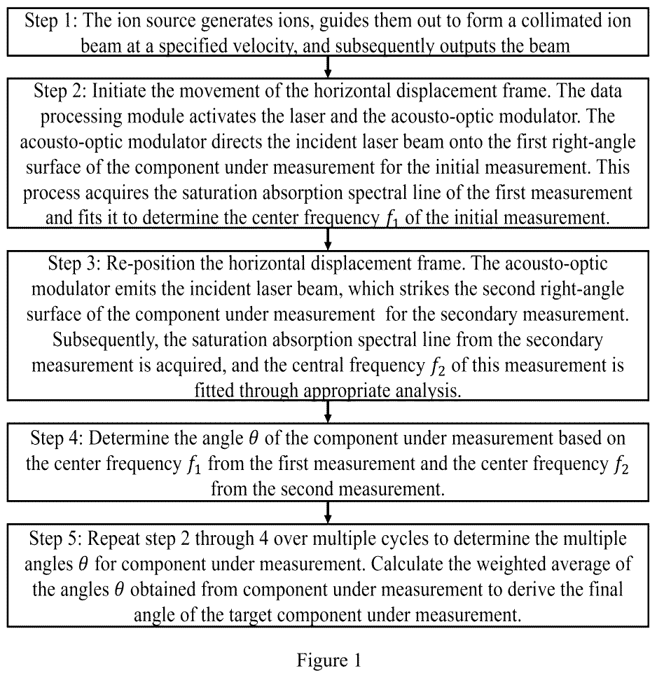

FIG. 2 depicts a structural schematic diagram of the device described in Example 1 of the present invention.

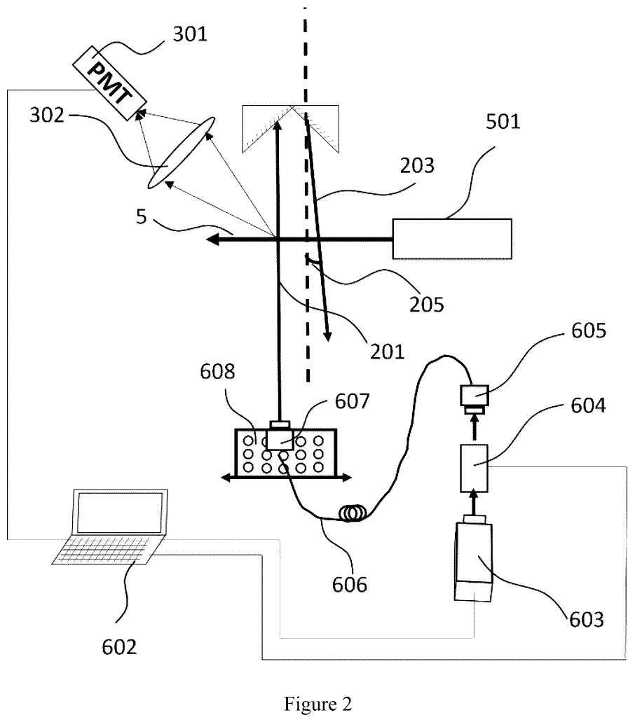

FIG. 3(a) depicts the incident laser in Example 2 of the present invention striking the first right-angle surface, followed by two reflections, with the emitted laser exiting from the second right-angle surface.

FIG. 3(b) depicts the incident laser in Example 2 of the present invention striking the second right-angle surface, followed by two reflections, with the emitted laser exiting from the first right-angle surface.

FIG. 4 displays the transition spectrum of metastable lithium ions and the residual map obtained from linear fitting of the transition spectrum of metastable lithium ions as observed in Example 2 of the present invention; where, (a) displays the transition spectrum of metastable lithium ions as observed in Example 2 of the present invention; (b) shows the residual map obtained from linear fitting of the transition spectrum of metastable lithium ions in Example 2 of the present invention.

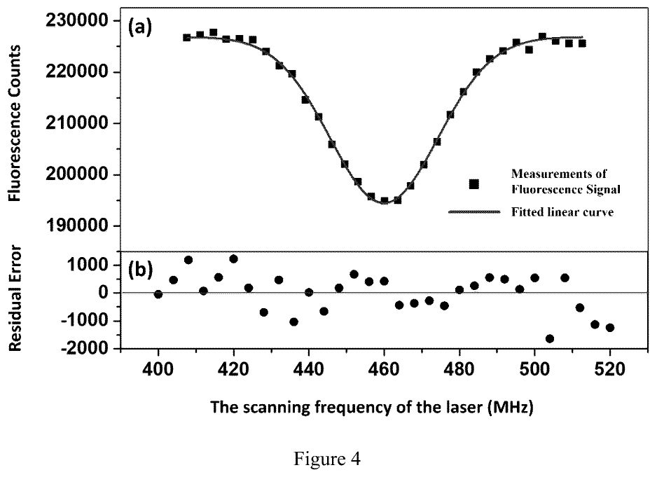

The attached drawing includes markings and their corresponding component names as follows:
1—the component under measurement, 101—the first right-angle surface, 102—the second right-angle surface, 201—the incident laser, 203—the emitted laser, 205—the angle between the incident laser and the emitted laser, 301—photomultiplier tube, 302—imaging lens, 401—the first reference plane, 402—angle between the second perpendicular surface and the first reference plane, 403—the second reference plane, 404—angle between the first perpendicular surface and the second reference plane, 5—ion beam, 501—ion source, 602—the data processing module, 603—laser, 604—the acousto-optic modulator, 605—first fiber coupling head, 606—optical fiber, 607—second fiber coupling head, 608—horizontal displacement frame.

### DETAILED DESCRIPTION OF THE EMBODIMENTS

In order to facilitate the understanding and implementation of the present invention by those skilled in the art, the following detailed description of the present invention is provided in conjunction with specific embodiments. These embodiments are presented for illustrative purposes only, to further elucidate the principles of the invention, and should not be construed as limiting the scope of the invention in any way.

### Example 1

A high-precision right-angle detection device is presented, comprising the component under measurement 1, an ion source (In this embodiment, the ion source of metastable lithium ions is chosen), a laser modulation module, a fluorescence collection module, and a data processing module 602. The component under measurement 1 features two right-angled surfaces, with the angle between these surfaces being the right-angle to be measured. The laser modulation module generates a single-frequency and single-mode incident laser 201. This incident laser 201 is aligned parallel to the bisector of the angles formed by the two right-angled surfaces of the component under measurement 1. The laser 201 is directed onto one of the right-angled surfaces of the component under measurement 1. After undergoing two reflections, the emitted laser 203 exits from the other right-angled surface. The metastable lithium ion source is prepared, and metastable lithium ions are extracted to form an ion beam at a predetermined velocity (in this embodiment, the velocity is set to 1.1×10⁵ m/s). Subsequently, the ion beam is collimated and directed perpendicularly to the incident laser 201. The collimated ion beam traverses both the incident laser 201 and the emitted laser 203, where these lasers excite the metastable lithium ion transitions and induce fluorescence emissions. The fluorescence collection module captures the emitted fluorescence signals from the metastable lithium ions and converts them into electrical signals for transmission to the data processing module 602. Based on the electrical signals and the laser frequency provided by the laser modulation module, the data processing module 602 determines the saturation absorption spectral line. The central frequencies of the saturated absorption spectra are then fitted and obtained. Additionally, the data processing module 602 is interconnected with the ion source, the laser modulation module, and the fluorescence collection module via signal transmission lines.

The incident laser 201 is parallel to the angle bisectors of the two right-angle surfaces of the component under measurement 1. Additionally, the planes containing the incident laser 201 and the emitted laser 203 are perpendicular to the angle bisectors of the two right-angle surfaces of the component under measurement 1.

In this embodiment, the ion source for lithium ions can also be replaced by an ion source, atomic source, or molecular source of other species (e.g., helium atom beam source, calcium atom beam source, iodine molecule beam source).

The laser modulation module comprises the laser 603, the acousto-optic modulator 604, the first fiber coupling head 605, the second fiber coupling head 607, the optical fiber 606, and the horizontal displacement frame 608. The output of the laser 603 is connected to the input of the acousto-optic modulator 604. The emission end of the acousto-optic modulator 604 is coupled to one end of the optical fiber 606 via the first fiber coupling head 605, while the other end of the optical fiber 606 is connected to the second fiber coupling head 607. The second fiber coupling head 607 is mounted on the horizontal displacement frame 608 and positioned at the same height as the component under measurement 1. Additionally, the second fiber coupling head 607 is aligned with one of the right-angle surfaces of the component under measurement 1. The data processing module 602 is interfaced with the modulation input terminal of the acousto-optic modulator 604 and the laser 603 through signal transmission lines.

The fluorescence collection module comprises an imaging lens 302 and a photomultiplier tube 301. The data processing module 602 is connected to the photomultiplier tube via a signal transmission line. The imaging lens 302 focuses the fluorescence signal emitted by metastable lithium ions onto the photosensitive surface of the photomultiplier tube 301. Subsequently, the photomultiplier tube 301 detects the fluorescence signal and converts it into a voltage pulse signal, which is then transmitted to the data processing module 602. Based on the voltage pulse signal and the laser frequency output by the laser 603, the data processing module 602 analyzes the line shape of the saturated absorption spectrum and performs fitting to determine the center frequency of the spectrum.

Laser 603 is employed to generate a single-frequency and single-mode incident laser beam 201. The acousto-optic modulator 604 is utilized to scan the laser frequency emitted by Laser 603 and output a frequency-swept laser. The horizontal displacement stage 608 aligns the second coupling head with the right-angle surface of the component under measurement 1, ensuring that the horizontal position of the second coupling head is adjusted so that the incident laser beam 201 transmitted to the second coupling head can be horizontally incident on either the first right-angle surface 101 or the second right-angle surface 102 of the component under measurement 1.

Metastable lithium-ion transitions emit isotropic fluorescence signals, a portion of which are collected by the imaging lens 302. The imaging lens 302 focuses these collected fluorescence signals onto the photosensitive surface of the photomultiplier tube 301 (PMT). Upon detection of the fluorescence signals by the photomultiplier tube 301, the signals are subsequently converted into voltage pulse signals.

The data processing module 602, which may utilize an industrial control computer, is responsible for controlling and fine-tuning the parameters of the laser 603, such as wavelength and power. The data processing module 602 is interfaced with the acousto-optic modulator 604 to perform spectral scanning by adjusting the laser frequency. Additionally, the data processing module 602 reads the voltage pulse signals from the fluorescence signal and synchronizes the timing with the frequency scan conducted by the acousto-optic modulator 604. Furthermore, the data processing module 602 adjusts the position of the horizontal moving frame, thereby regulating the horizontal positioning of the second coupling head.

### Example 2

A high-precision right-angle detection method, which employs a high-precision right-angle detection device as detailed in Example 1, consists of the following steps:

The present invention calculates the first-order Doppler effect of the incident laser 201 and the emitted laser 203 by utilizing two right-angle surfaces of the component under measurement 1 to reflect the lasers. This is achieved through the measurement of ion spectra of metastable lithium ions using both the incident laser 201 and the emitted laser 203. Subsequently, the angular difference between the incident laser 201 and the emitted laser 203 (that is the angle 205 formed between the incident laser 201 and the emitted laser 203), is deduced based on the first-order Doppler effect. Finally, the right angle of the component under measurement (1) is calculated. The method proposed in this invention can enhance the accuracy of angular measurements to within 0.01 arcseconds, achieving or even surpassing the precision of 10⁻⁸ radians.

In this embodiment, a metastable lithium ion source is utilized. Alternatively, the ion source of metastable lithium ions in this embodiment can be substituted with an ion source of other types, an atomic source, or a molecular source, depending on the specific requirements of the application.
Step 1: The data processing module 602 activates the ion source for metastable lithium ions. Generate metastable lithium ions from the ion source and extract an ion beam with a velocity v of 1.1×10⁵ m/s to form the metastable lithium ions. Subsequently, output the collimated ion beam.
Step 2: Initiate the movement of the horizontal displacement frame 608. Subsequently, the data processing module 602 activates the laser 603 and the acousto-optic modulator 604. The acousto-optic modulator 604 generates an incident laser beam 201, which strikes the first right-angle surface 101 of the component under measurement 1. After undergoing two reflections, the emitted laser beam 203 is reflected off the second right-angle surface 102 for the initial measurement. The incident laser 201 and the emergent laser 203 excite the metastable lithium-ion transition, resulting in the emission of a fluorescence signal. Subsequently, the photomultiplier tube 301 detects this fluorescence signal, converts it into a voltage pulse signal, and transmits the voltage pulse signal to the data processing module 602. Based on the voltage pulse signal and the laser frequency provided by the laser 603, the data processing module 602 determines the saturation absorption spectral line corresponding to the first measurement, and the center frequency f₁ of the first measurement is determined through fitting based on the acquired saturated absorption spectral line. Leveraging the Doppler effect, the following relationship can be derived:

$${f}_{1} = {f}_{0} + \frac{{f}_{0} {β}^{2}}{2} + {f}_{0} β sin ϕ \qquad ( 1 )$$

In the formula, f₁ represents the center frequency of the spectral line obtained after the first measurement fitting. f₀ denotes the actual transition frequency of metastable lithium ions. β=v/c, where β is defined as the ratio of the velocity v of metastable lithium ions to the speed of light c. Additionally, φ represents the angle between the incident laser 201 and the emitted laser 203.
Step 3: Re-position the horizontal displacement frame 608. Subsequently, the data processing module 602 activates the laser 603 and the acousto-optic modulator 604. The acousto-optic modulator 604 emits the incident laser beam 201, which strikes the second right-angle surface 102 of the component under measurement 1. After undergoing two reflections, the emitted laser beam 203 is reflected off the first right-angle surface 101 for a second measurement. The incident laser 201 and the emergent laser 203 excite the metastable lithium-ion transition, resulting in the emission of a fluorescence signal. Subsequently, the photomultiplier tube 301 detects this fluorescence signal, converts it into a voltage pulse signal, and transmits the voltage pulse signal to the data processing module 602. The data processing module 602 then derives the saturation absorption spectral line for the second measurement by analyzing the voltage pulse signal in conjunction with the laser frequency output from the laser 603. Finally, through Gaussian fitting applied to the saturation absorption spectral line of the second measurement, the center frequency f₂ is obtained. Leveraging the Doppler effect, the following relationship can be derived:

$${f}_{1} = {f}_{0} + \frac{{f}_{0} {β}^{2}}{2} - {f}_{0} β sin ϕ \qquad ( 2 )$$

Step 4: Determine the angle θ of the component under measurement (1) based on the center frequency f₁ from the first measurement and the center frequency f₂ from the second measurement.

The difference between the center frequency f₁ of the spectral line fitted after the first measurement and the center frequency f₂ of the spectral line fitted after the second measurement is calculated, yielding f₁-f₂=2β sin φ. By eliminating the β² term, the impact of inaccuracies in ion velocity is mitigated, thereby enabling the derivation of the following result:

$$ϕ = arcsin \frac{{f}_{1} - {f}_{2}}{2 {f}_{0} β} \qquad ( 3 )$$

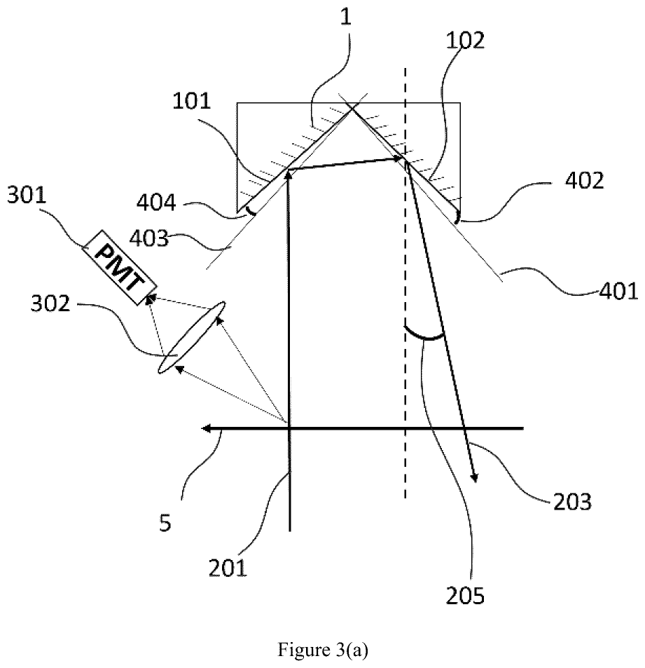

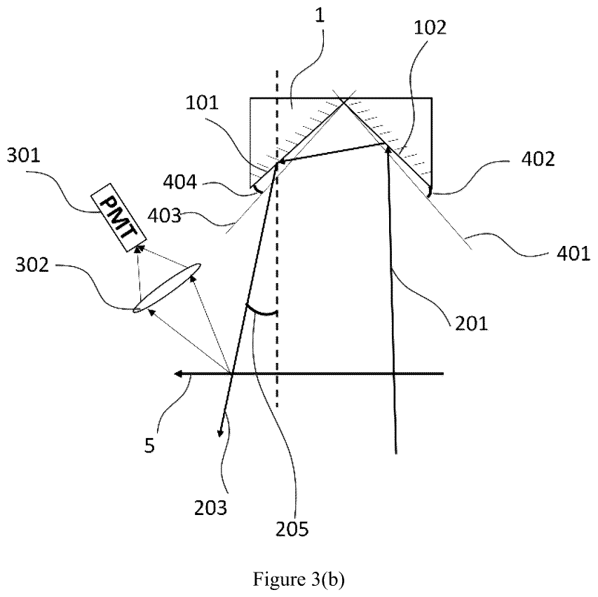

As depicted in FIGS. 3(a) and 3(b), the first right-angle surface 101 of the component under measurement 1 forms a right angle π/2 with the first reference plane 401. Likewise, the second right-angle surface 102 of the component under measurement 1 forms a right angle π/2 with the second reference plane 403. Subsequently, the angle 404 between the first right-angle surface 101 and the second reference plane 403 is precisely equal to the angle 402 between the second right-angle surface 102 and the first reference plane 401. Denoting both angles as a, the angle of the component under measurement 1 can be determined using the relationships α=π−π/2 and φ=2α:

$$θ = \frac{π}{2} + \frac{ϕ}{2} \qquad ( 4 )$$

Step 5: Repeat step 2 through 4 over multiple cycles to determine the multiple angles θ for component under measurement 1. Calculate the weighted average of the angles θ obtained from component under measurement 1 to derive the final angle of the target component under measurement 1.

The present invention utilizes the saturated absorption spectrum of highly stable lithium ions, characterized by f₀ value of 546 THz and β value of 3.4×10⁻⁴. Based on Equation (3), the measurement accuracy for the angle θ of component under measurement 1 is calculated as 5 kHz/(546 THz×3.4×10⁻⁴)=2.7×10⁻⁸ radians, which corresponds to 0.006 arcseconds.

The method of the present invention involves obtaining a saturated absorption spectrum under the condition where the incident laser 201 and the emitted laser 203 are parallel. This saturated absorption spectrum corresponds to the spontaneous emission fluorescence produced by ions whose movement speed matches the angle between the two interacting light beams (in this embodiment, that are the incident laser 201 and the emitted laser 203). The residual first-order Doppler frequency shift at the center of the obtained saturated absorption spectrum corresponds to the angular difference between the incident laser 201 and the emitted laser 203, which is equivalent to the deviation of the angle of the component under measurement from 90°. However, the precise evaluation of the actual central frequency f₀ of the ion transition, as well as other systematic errors such as the second-order Doppler frequency shift, presents significant challenges. Consequently, the angular difference cannot be determined with a single measurement. To address this limitation, a second measurement is introduced by either repositioning the component under measurement or relocating the laser so that the paths of the incident laser 201 and the emitted laser 203 are reversed. This process yields an additional center frequency value. The error terms embedded in the center frequency values from both measurements remain consistent, except for the residual first-order Doppler term, which exhibits equal magnitude but opposite sign. By leveraging the difference between these two values, the residual first-order Doppler term can be isolated, while other systematic errors are effectively canceled out. Ultimately, the laser angular difference is determined. Finally, the deviation angle difference of 90° for the component under measurement 1 is obtained.

The frequency f₀ of the present invention lies within the visible light frequency band, spanning from several hundred to several thousand terahertz (THz). The ion velocity exceeds >10⁵ m/s, corresponding to β>3.3×10⁻⁴. The measurement accuracy of f₁-f₂ can reach within kilohertz (kHz), allowing us to infer that the measurement accuracy of θ is better than 1 kHz/(100 THz×3.3×10⁻⁴)=3×10⁻⁸ radians, which corresponds to 0.007 arcseconds. This level of measurement accuracy surpasses the current mainstream angular measurement limit.

It is worth noting that the embodiments described in this invention are merely illustrative examples reflecting the essence of the present invention. A person skilled in the relevant technical field may make various modifications, supplements, or adopt similar alternatives to the described embodiments, without deviating from the spirit of the present invention or exceeding the scope as defined in the appended claims.

What is claimed is:

1. A high-precision right-angle detection method, characterized in that it comprises the following steps:
Step 1: The data processing module (602) activates the ion source (501); Subsequently, the ion source (501) generates ions and directs them to form an ion beam (5) at a predetermined velocity; The collimated ion beam (5) is then output for further processing;
Step 2: Initiate the movement of the horizontal displacement frame (608); Subsequently, the data processing module (602) activates the laser (603) and the acousto-optic modulator (604); The acousto-optic modulator (604) generates an incident laser beam (201), which strikes the first right-angle surface (101) of the component under measurement (1); After undergoing two reflections, the emitted laser beam (203) is reflected off the second right-angle surface (102) for the initial measurement; A saturated absorption spectral line is obtained from this first measurement, and the center frequency f₁ of the first measurement is determined through fitting based on the acquired saturated absorption spectral line;
Step 3: Re-position the horizontal displacement frame (608); Subsequently, the data processing module (602) activates the laser (603) and the acousto-optic modulator (604); The acousto-optic modulator (604) emits the incident laser beam (201), which strikes the second right-angle surface (102) of the component under measurement (1); After undergoing two reflections, the emitted laser beam (203) is reflected off the first right-angle surface (101) for a second measurement; A saturated absorption spectral line is obtained from the second measurement, and the center frequency f₂ of the second measurement is determined through fitting based on this saturated absorption spectral line;
Step 4: Determine the angle θ of the component under measurement (1) based on the center frequency f₁ from the first measurement and the center frequency f₂ from the second measurement;
Step 5: Repeat step 2 through 4 over multiple cycles to determine the multiple angles θ for component under measurement (1); Calculate the weighted average of the angles θ obtained from component under measurement (1) to derive the final angle of the target component under measurement (1).

2. The high-precision right-angle detection method as described in claim 1, characterized in that the laser path of the first measurement is oriented in the opposite direction to that of the second measurement.

3. The high-precision right-angle detection method as described in claim 2, characterized in that at step 4, calculates the angle θ of the component under measurement (1) using the following formula:
$$ϕ = arcsin \frac{{f}_{1} - {f}_{2}}{2 {f}_{0} β}$$
$$θ = \frac{π}{2} + \frac{ϕ}{2}$$
In the formula, φ represents the angle (205) between the incident laser (201) and the emitted laser (203), f₀ represents the actual transition frequency of the ion, and β signifies the ratio of the ion's velocity to the speed of light.

4. A device for implementing the high-precision right-angle detection method as described in claim 1, comprising a component under measurement (1), characterized by further including an ion source (501), a laser modulation module, a fluorescence collection module, and a data processing module (602); The laser modulation module generates an incident laser beam (201) that strikes one of the right-angle surfaces of the component under measurement (1); After two reflections, the emergent laser beam (203) is reflected off another right-angle surface; The ion source (501) prepares ions and accelerates them to form an ion beam (5) with a predetermined velocity; Subsequently, the ion beam (5) is collimated and directed perpendicularly to the incident laser beam (201); The collimated ion beam (5) passes through both the incident laser beam (201) and the emergent laser beam (203); These laser beams excite ion transitions, causing the ions to emit fluorescence signals; The fluorescence collection module captures the emitted fluorescence signals, converts them into electrical signals, and outputs them to the data processing module (602); Based on the electrical signals and the laser frequency provided by the laser modulation module, the data processing module (602) analyzes the saturated absorption spectrum to determine its center frequency; Additionally, the data processing module (602) is connected via signal transmission lines to the ion source (501), the laser modulation module, and the fluorescence collection module.

5. The high-precision right-angle detection device as described in claim 4, characterized in that the incident laser (201) is parallel to the angle bisector of the two right-angle surfaces of the component under measurement (1), and the plane defined by the incident laser (201) and the emitted laser (203) is perpendicular to the angle bisector of the two right-angle surfaces of the component under measurement (1).

6. The high-precision right-angle detection device as described in claim 5, characterized in that the laser modulation module comprises a laser (603), an acousto-optic modulator (604), a first fiber coupling head (605), a second fiber coupling head (607), an optical fiber (606), and a horizontal displacement frame (608); The emission end of the laser (603) is optically coupled to the input end of the acousto-optic modulator (604); The output end of the acousto-optic modulator (604) is connected to one end of the optical fiber (606) via the first fiber coupling head (605), while the other end of the optical fiber (606) is connected to the second fiber coupling head (607); The second fiber coupling head (607) is mounted on the horizontal displacement frame (608) and positioned at the same height as the component under measurement (1); Furthermore, the second fiber coupling head (607) is aligned with one of the right-angle surfaces of the component under measurement (1); The data processing module (602) is electrically connected to both the modulation input terminal of the acousto-optic modulator (604) and the laser (603) via signal transmission lines.

7. The high-precision right-angle detection device as described in claim 6, characterized in that the fluorescence collection module comprises an imaging lens (302) and a photomultiplier tube (301); The data processing module (602) is connected to the photomultiplier tube (301) via a signal transmission line; The imaging lens (302) focuses the fluorescence signal emitted by the ions onto the photosensitive surface of the photomultiplier tube (301); Upon detecting the fluorescence signal, the photomultiplier tube (301) converts it into a voltage pulse signal, which is subsequently transmitted to the data processing module (602); Based on the voltage pulse signal and the laser frequency output by the laser (603), the data processing module (602) determines the line shape of the saturated absorption spectrum and performs fitting to obtain the center frequency of the saturated absorption spectrum.

8. The high-precision right-angle detection device as described in claim 7, characterized in that the ion source (501) can be replaced by an atomic source or a molecular source.
